(19) United States
(12) Patent Application Publication
(10) Pub. No.: US 2005/0186313 A1
(43) Pub. Date: Aug. 25, 2005

(54) Method for decorating a fruit surface

(76) Inventor: Paul F. Manley, Marietta, GA (US)

Correspondence Address: Law Office of Steven B. Leavitt, 9914 Waterview Parkway, Rowlett, TX, 75089, US

(21) Appl. No.: 10/784,707

(22) Filed: Feb. 23, 2004

(51) Int. Cl. A23G 1/00

(52) U.S. Cl. 426/383

(57) ABSTRACT

A method for decorating fruit with a design wherein the design is printed on an edible sheet or an edible film with a peelable backing. The printed design is then attached to fruit which is coated with an edible coating. If an edible sheet is used, then the edible sheet may be the same color as the edible coating.

### BACKGROUND OF THE INVENTION

1. Technical Field

The invention relates to decorating foodstuff with an edible design and more particularly to decorating coated fruit with an edible design.

2. Description of Related Art

Chocolate covered strawberries are a confection often provided at various celebratory events such as weddings, anniversaries, New Years Eve parties or on occasions such as birthdays, anniversaries, or holidays. Strawberries are often covered with nuts, chips, or coconut applied to the surface of the chocolate coating or are minimally decorated by piping chocolate onto them in a decorative design. By coating the chocolate on the strawberry, a more artistic and elegant appearance may be attained. Decorations though with more complex designs are difficult to produce because of the relatively small surface area and non-planar surface. In addition, repeating detailed designs or written messages for a plurality of strawberries is difficult, time consuming, and not cost effective.

What is needed is a method for decorating fruit, such as strawberries, with a detailed design wherein the design can be relatively easily repeated, is cost effective, and is not difficult or time consuming to produce.

Several methods and apparatus exist for making and using edible designs for use on foodstuff such as baked goods and chocolate bars. For example, U.S. Pat. No. 6,376,000 B1, issued Apr. 23, 2002, to Waters titled “Method of Creating Painted Chocolate” discloses a method of forming a chocolate mold having an image printed thereon. The method includes printing an image on edible paper using a printer having food coloring loaded into the cartridge of the printer. The edible paper and image are secured to the mold in one of two methods. The first includes placing the edible paper within a mold with the image facing a side of the mold, pouring chocolate into the mold, and allowing the chocolate to harden. Then, removing the hardened chocolate and edible paper from the mold to create a chocolate mold with an image printed thereon. The second method includes securing the edible paper to a hardened chocolate mold with an edible adhesive such as gum arabic. The methods disclosed in Waters are for chocolate molds which are planar and relatively flat.

U.S. Pat. No. 6,616,958 B1, issued Sep. 9, 2003, to Stewart titled “Method of Making and Using an Edible Film for Decorating Foodstuffs” discloses an edible film for decorating foodstuffs such as baked goods. The edible film is composed of an edible polymer film which is releasably mounted on a flexible substrate to provide decorations for baked goods. The method disclosed in Stewart is for baked goods which are planar and relatively flat.

U.S. Pat. No. 5,017,394, issued May 21, 1991, to Macpherson, et al titled “Method for Making Edible Base Shapes Having Pictorial Images for Decorating Foodstuffs” discloses using a silk screen method to form thin, flat, flexible images or transfers directly onto release paper for use in decorating foodstuffs. The images or transfers are only used to decorate cakes, cookies, and chocolate covered candies, not fruits.

What is needed is a method for decorating fruit with a design wherein the design can be relatively easily repeated, is cost effective, and is not difficult or time consuming to produce. The prior art does not disclose or suggest such a method.

### SUMMARY OF THE INVENTION

The present invention provides a method for decorating fruit with a design wherein the design can be relatively easily repeated, is cost effective, and is not difficult or time consuming.

The method includes selecting a fruit, selecting a design to decorate the fruit, printing the design, coating the fruit with an edible coating, and attaching the printed design to the fruit. The design may be printed on an edible sheet or an edible film with a peelable backing. Such printing methods allow for repeating detailed designs or written messages in a relatively easy, cost effective, and timely manner. In addition, the edible sheets or edible film on transfer sheets can be cut to a size that allows for decorating relatively smaller fruit such as strawberries.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a block diagram depicting decorating fruit with a design according to the present invention;

FIG. 2 is a block diagram depicting decorating fruit with a design printed on an edible sheet according to the present invention; and

FIG. 3 is a block diagram depicting decorating fruit with a design printed on an edible film with a peelable backing according to the present invention.

### DETAILED DESCRIPTION

In the descriptions that follow, like steps are marked throughout the specification and drawings with the same numerals, respectively in the interest of clarity and conciseness.

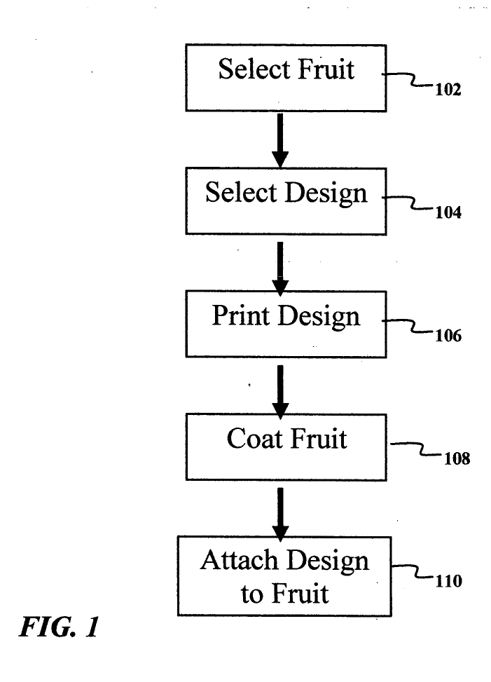

FIG. 1 shows the steps used to decorate fruit with a design. First, the desired fruit is selected, Step 102. Then the design used to decorate the fruit is determined, Step 104. After the design has been selected, it is printed, Step 106. Next the fruit is coated with an edible coating, Step 108. Finally, the design is attached to the fruit, Step 110.

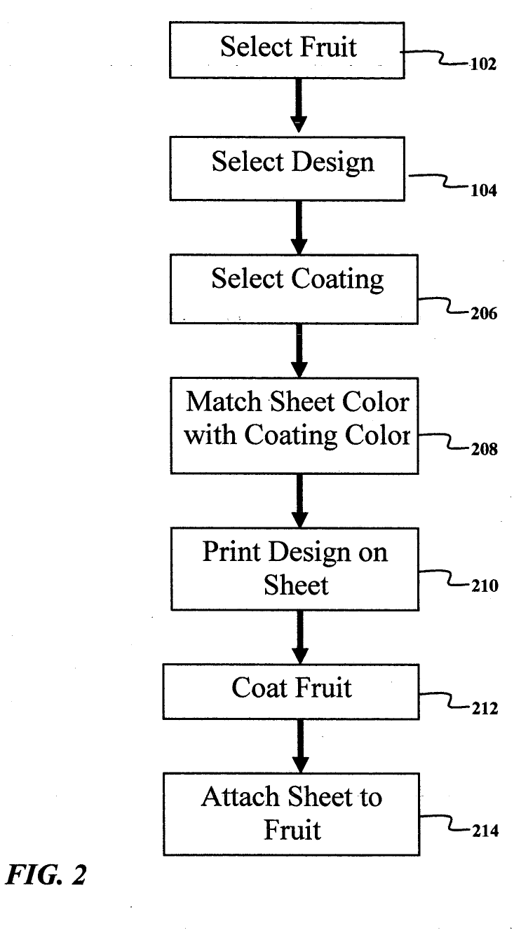

FIG. 2 shows the steps used to decorate fruit with a design printed on an edible sheet. After, the desired fruit and design are selected, Steps 102 and 104, the coating is selected, Step 206. Then, the color of the edible sheet is selected to match the color of the coating, Step 208. Next, the design is printed on the edible sheet, Step 210. After the design is printed, the fruit is coated with the edible coating, Step 212. Finally, the edible sheet is attached to the fruit, Step 214.

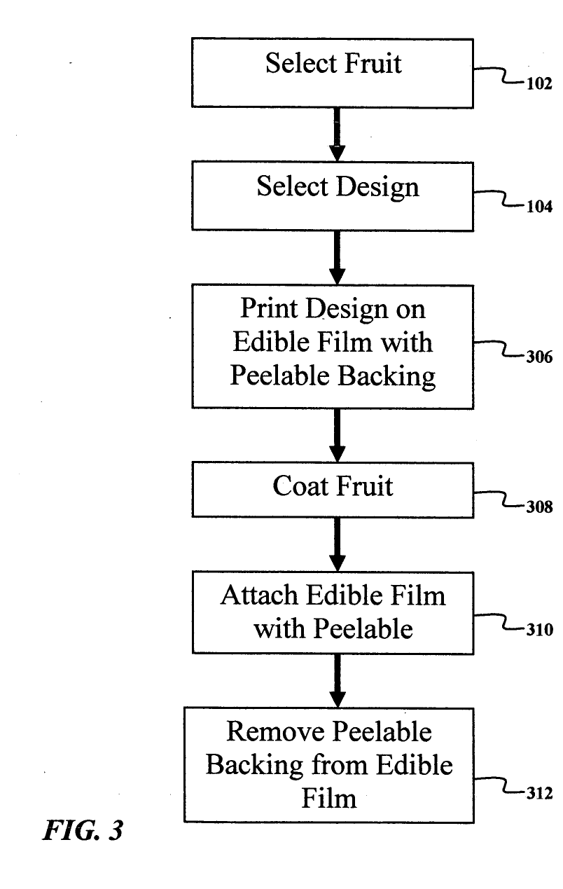

FIG. 3 shows the steps used to decorate fruit with a design printed on an edible film with a peelable backing. After, the desired fruit and design are selected, Steps 102 and 104, the design is printed on the edible film with a peelable backing, Step 306. Next, the fruit is coated with an edible coating, Step 308. Then, the edible film with the peelable backing is attached to the fruit, Step 310. Finally, the peelable backing is removed from the edible film, Step 312. The invention will now be described in more detail.

With reference to FIGS. 1, 2 and 3, the desired fruit is selected, Step 102. Selection may be based on the occasion, season, size of the design, or other factors. For example, strawberries are a popular fruit for use at a wedding while apples are a popular fruit in the fall and for use during Halloween. Other fruit that could be selected include bananas, cherries, orange slices, pears, and the like. After the fruit is selected, the design used to decorate the fruit is determined, Step 104.

The selection of the design may be based on the occasion for which the fruit will be decorated or the size of the fruit. For example, to decorate strawberries for a wedding, the design may be the bride and groom's name, a silhouette of a couple holding hands, or an actual picture of the couple. For Halloween, the design may be a witch on a broom. The size of the design depends on the size of the fruit. For a strawberry, the design would be relatively small while for an apple, the design may be relatively large. After the design has been selected, it is printed, Step 106, FIG. 1.

There are many methods for printing a design for use on baked goods. Two of the most common methods include printing on an edible sheet and printing onto an edible film with a peelable backing. Suitable edible sheets are commercially available from Lucks Food Decorating Company located in Tacoma, Wash. and PhotoFrost located in Williston, Fla. To print the design, an inkjet printer such as model number i550 commercially available from Canon U.S.A. Inc. located in Lake Success, N.Y. is used. A similar inkjet printer may be used such as those available from Canon, Hewlett Packard, Epson, or any other printer which is able to receive ink cartridges containing micro filtered food grade coloring.

The ink cartridge can be a black ink cartridge but is preferably a color cartridge filled with numerous colors of food grade coloring such as red, yellow, blue and black. Some printers, such as the i550, take multiple cartridges wherein each cartridge is individually filled with black, red, yellow, or cyan food coloring to allow a full range of colors to be printed through color mixing. The colors used are determined by the colors needed to produce the desired image. Ink cartridges filled with food coloring are known in the art and commercially available from Lucks Food Decorating Company located in Tacoma, Wash. and PhotoFrost located in Williston, Fla.

For designs printed on edible paper, the edible paper is typically made from sugar, corn syrup, corn starch, microcrystaline cellulose, vegetable oil, titanium dioxide and a preservative. The ingredients are mixed together to form a pasty material and rolled into a flat sheet of edible paper on a piece of wax paper or plastic wherein the wax paper or plastic provides support. The color of the edible paper is white and is colored during the printing process if so desired. Furthermore, the background color with which the edible paper may be covered may be made to match the color of the coating that will be applied to the fruit. With the background color matching the coating applied to a fruit surface, a substantially seamless transition from the surface coating to the printed design is achieved.

After the edible paper is positioned on and supported by the wax paper, the edible paper and wax paper backing are loaded into the printer. At the time of loading, the edible paper is typically moist and pliable so as to easily load into the printer and be able to retain the ink used for printing. The printer is connected to a processor such as a computer via a connection cable. The processor is used to generate an image or read an image from a storage medium such as a disk drive. Also, the processor may be loaded with a graphics program to allow an image to be generated using a keyboard and a mouse. The image generated may be viewed on a monitor connected to the processor. The processor, disk drive, keyboard, mouse and monitor are all conventional computer devices normally used to generate an image. Once the image is created, the printer is used to print the image on the edible paper. When the printer finishes printing the image, the edible paper is removed from the printer and cut to a desired size and shape.

The second method for printing a design for use on foodstuff includes printing onto an edible film associated with a peelable backing. The edible film is preferably a thin layer of chocolate. Other kinds of edible films may also be used such as a water soluble polymer film, manufactured by Dow Chemical Company of Midland, Mich. under the trademark METHOCEL. METHOCEL encompasses a range of both methylcellulose and hydroxypropyl methylcellulose in a wide range of viscosities.

The peelable backing is a food product compatible, flexible sheet such as acetate which has the properties of releasably adhering to the edible film. In addition to acetate, other food product compatible substrates may also be used such as a 3 mil DuPont EB-11 mylar sheet.

The edible film and peelable backing are associated in a manner known in the art which allows for hand peeling of the peelable backing from the edible film and further of providing mechanical handling integrity for the edible film so that the edible film may be processed, such as by printing and cutting. An example of an acceptable edible film with a peelable backing is a thin chocolate film on acetate wherein the thin chocolate is the edible film and the acetate is the peelable backing. Chocolate films on acetate are commercially available from American Chocolate Designs located in Alpharetta, Ga.

The design is printed onto the edible film through a process known in the art as screen printing or silk screening. After the design is printed, the edible film with peelable backing is cut to a desired size and shape. After the edible sheet or edible film with peelable backing is cut to a desired size and shape, the fruit is coated with an edible coating, Step 108.

The edible coating may be dark chocolate, milk chocolate, white chocolate, caramel, confectionary coating, or some other similar coating. For example, if strawberries are to be used in a wedding, then the strawberries may be coated in dark chocolate. If apples are to be used at Halloween, then a coating of caramel may be applied. Preferably the edible coating is the same color as the edible sheet the design is printed on. After the fruit has been coated with an edible coating, the design is attached to the coated fruit, Step 110.

The method of attaching the design to the fruit depends on how the design is printed. If the design is printed on an edible sheet, then the edible sheet is removed from the wax paper backing and applied to the coated fruit while the coating is still wet. The placement of the design may be manipulated to achieve an aesthetically pleasing effect. The design manipulation may be carried out by hand or with a small tool such as the tine of a fork, a toothpick, or ice pick. Because the coating is wet, the edible sheet can stick to the coating without any glue or adhesive. If the coating is dry or the edible sheet will not stick to the coated fruit, then an edible adhesive such as gum arabic may be used. In another embodiment, the coating and/or edible sheet may be temporarily moistened with a spray bottle to allow the edible sheet to stick to the coating. Next, the coating, or adhesive if applied, is allowed to dry whereby the design becomes fixedly attached to the coated fruit.

If the design is printed onto an edible film with a peelable backing, then, while the coating is still wet, the edible film is pressed against the coated fruit such that the design on the edible film is sandwiched between the fruit coating and the peelable backing. The placement of the design may be manipulated to achieve an aesthetically pleasing effect. The design manipulation may be carried out by hand or with a small tool such as the tine of a fork, a toothpick, or ice pick. As with the method for applying the edible sheets, if the coating is dry or the edible film will not stick to the coated fruit, then an edible adhesive such as gum arabic may be used. In another embodiment, the coating and/or edible film may be temporarily moisten with a spray bottle to allow the edible film to stick to the coating. After the coating, and adhesive if used, is dry, the peelable backing is removed from its association with the edible film whereby the printed design remains on the coated fruit.

Although the invention has been described with reference to one or more preferred embodiments, this description is not to be construed in a limiting sense. There is modification of the disclosed embodiments, as well as alternative embodiments of this invention, which will be apparent to persons of ordinary skill in the art, and the invention shall be viewed as limited only by reference to the following claims.

1. A method for decorating fruit with a design, the method comprising the steps of:
selecting a fruit;
selecting a design to decorate the fruit;
printing the design;
coating the fruit with an edible, substantially water-intolerant coating; and
attaching the design to the coated fruit.

2. The method of claim 1 wherein the design is printed on an edible sheet.

3. The method of claim 2 wherein the color of the frosting sheet is the same color as the coating.

4. The method of claim 2 wherein the design is printed on the frosting sheet by an inkjet printer.

5. The method of claim 1 wherein the design is printed on an edible film.

6. The method of claim 5 wherein the edible film is releasably attached to a peelable backing.

7. The method of claim 6 wherein the peelable backing is acetate.

8. The method of claim 5 wherein the edible film is chocolate.

9. The method of claim 8 wherein the chocolate is milk chocolate.

10. The method of claim 8 wherein the chocolate is white chocolate.

11. The method of claim 5 wherein the edible film is caramel.

12. The method of claim 1 wherein the coating is a confectionary coating.

13. The method of claim 22 wherein the chocolate is milk chocolate.

14. The method of claim 22 wherein the chocolate is white chocolate.

15. The method of claim 1 wherein the coating is caramel.

16. The method of claim 1 wherein the fruit is selected from the group consisting of strawberries, apples, bananas, cherries, orange slices, and pears.

17. The method of claim 1 wherein the design is attached before the coating is dry.

18. The method of claim 1 wherein the design attached using an adhesive.

19. A method for decorating fruit with a design, the method comprising the steps of:
selecting a fruit;
selecting a design to decorate the fruit;
printing the design on a frosting sheet;
coating the fruit with an edible coating; and
attaching the frosting sheet to the coated fruit.

20. A method for decorating fruit with a design, the method comprising the steps of:
selecting a fruit;
selecting a design to decorate the fruit;
printing the design on an edible film with a peelable backing;
coating the fruit with an edible coating; and
attaching the edible film to the coated fruit.

21. The method of claim 1 wherein the coating is flavored.

22. The method of claim 1 wherein the coating is chocolate.
